(19) United States
(12) Patent Application Publication
(10) Pub. No.: US 2025/0319481 A1
(43) Pub. Date: Oct. 16, 2025

(54) SHOWERHEAD ASSEMBLY

(71) Applicant: KOHLER CO, Kohler, WI (US)

(72) Inventors: SHENGHE CHEN, Nanchang (CN); Jovello T. Gomez, JR., Sheboygan, WI (US); Michael Soetaert, Sheboygan, WI (US); Jordan Meyers, San Francisco, CA (US); Coralee Sandee, Sheboygan Falls, WI (US)

(73) Assignee: KOHLER CO., Kohler, WI (US)

(21) Appl. No.: 19/173,440

(22) Filed: Apr. 8, 2025

(30) Foreign Application Priority Data
Apr. 12, 2024 (WO) PCT/CN2024/087477

(51) Int. Cl. B05B 1/18

(52) U.S. Cl. CPC B05B 1/185

(57) ABSTRACT

The present disclosure is generally directed towards a showerhead assembly configured to couple to a supply conduit extending through a surface. The showerhead assembly includes a showerhead configured to couple to the supply conduit, a showerhead configured to couple to the supply conduit, and a base component configured to couple to the intermediate component. The showerhead defines a plurality of nozzles. When the showerhead assembly is in a first configuration, the showerhead is positioned proximate the surface. When the showerhead assembly is in a second configuration, the intermediate component is coupled to the showerhead and the intermediate component is positioned proximate the surface. When the showerhead assembly is in a second configuration, the intermediate component is coupled to the showerhead and the intermediate component is positioned proximate the surface.

### CROSS-REFERENCE TO RELATED PATENT APPLICATION

This application claims the benefit of and priority to P.C.T. Application No. PCT/CN2024/087477, filed Apr. 12, 2024, which is incorporated herein by reference in its entirety.

### BACKGROUND

The present disclosure relates generally to showerhead assemblies. More specifically, the present disclosure relates to showerhead assemblies that are configured to be adjusted to change the configuration of a showerhead of the showerhead assemblies and/or an aesthetic of the showerhead.

Many residential spaces (e.g., homes, condominiums, apartments, hotels, motels, etc.) and recreational spaces (e.g., gyms, spas, health clubs, etc.) have showerhead assemblies (e.g., showerhead kits, etc.) that include showerheads (e.g., shower nozzles, sprayer nozzles, etc.). The showerheads may be installed in bathroom configurations (e.g., showers, bathtubs, etc.) to provide water to a person during a shower. However, often the showerheads are static components (e.g., prefabricated, unchanging, etc.) that are difficult to modify after the showerheads are received from a manufacturer (e.g., a vendor, etc.). For example, the showerheads may be configured to have a certain structure that would be difficult for a person to modify after receiving the showerheads from the manufacturer. Additionally, even if the showerheads could be modified after the showerheads are received from the manufacturer, it is even more difficult to modify the showerheads after the showerheads are installed in the bathroom configurations (e.g., on a ceiling of the bathroom configurations, on a wall of the bathroom configurations, etc.) For example, a showerhead may need to be uninstalled from the bathroom configuration in order to modify the showerhead.

It would be advantageous to provide a showerhead assembly that addresses one or more of the aforementioned issues.

### SUMMARY

One embodiment relates to a showerhead assembly configured to couple to a supply conduit extending through a surface. The showerhead assembly includes a showerhead configured to couple to the supply conduit, a showerhead configured to couple to the supply conduit, and a base component configured to couple to the intermediate component. The showerhead defines a plurality of nozzles. When the showerhead assembly is in a first configuration, the showerhead is positioned proximate the surface. When the showerhead assembly is in a second configuration, the intermediate component is coupled to the showerhead and the intermediate component is positioned proximate the surface. When the showerhead assembly is in a second configuration, the intermediate component is coupled to the showerhead and the intermediate component is positioned proximate the surface.

Another embodiment relates to a showerhead assembly configured to couple to a surface. The showerhead assembly includes a base portion configured to couple to the surface, an arm portion coupled to the base portion, and a showerhead coupled to the arm portion. The base portion defines a water supply inlet configured to receive a flow of water. The arm portion includes a first arm defining a first conduit fluidly coupled to the water supply inlet and a second arm defining a second conduit fluidly coupled to the water supply inlet. The first conduit is configured to receive a first portion of the flow of water from the water supply inlet. The second conduit is configured to receive a second portion of the flow of water from the water supply inlet. The showerhead defines a showerhead conduit fluidly coupled to the first conduit and the second conduit. The showerhead is conduit configured to receive the first portion of the flow of water from the first conduit and the second portion of the flow of water from the second conduit.

Yet another embodiment relates to a showerhead assembly configured to couple to a supply conduit extending through a surface. The showerhead assembly includes a showerhead configured to couple to the supply conduit. The showerhead defines a showerhead conduit fluidly coupled to the supply conduit and configured to receive a flow of water from the supply conduit, a plurality of nozzles fluidly coupled to the showerhead conduit configured to output the flow of water from the showerhead assembly, and an outer groove configured to selectively receive a plurality of outer bands to facilitate selectively interchanging the plurality of outer bands.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a showerhead assembly, according to an exemplary embodiment.

FIG. 2 is an exploded view of the showerhead assembly of FIG. 1, according to an exemplary embodiment.

FIG. 3 is a perspective view of the showerhead assembly of FIG. 1 in a first configuration, according to an exemplary embodiment.

FIG. 4 is a perspective view of the showerhead assembly of FIG. 1 in a second configuration, according to an exemplary embodiment.

FIG. 5 is a perspective view of the showerhead assembly of FIG. 1 in a third configuration, according to an exemplary embodiment.

FIG. 6 is a perspective view of an outer band of the showerhead assembly of FIG. 1, according to an exemplary embodiment.

FIG. 7 is a perspective view of another outer band of the showerhead assembly of FIG. 1, according to an exemplary embodiment.

FIG. 8 is a perspective view of another showerhead assembly, according to an exemplary embodiment.

FIG. 9 is a side view of the showerhead assembly of FIG. 8, according to an exemplary embodiment.

FIG. 10 is a top view of the showerhead assembly of FIG. 8, according to an exemplary embodiment.

FIG. 11 is a perspective view of a portion of the showerhead assembly of FIG. 8, according to an exemplary embodiment.

FIG. 12 is a perspective view of the showerhead assembly of FIG. 8, according to an exemplary embodiment.

FIG. 13 is a cross-section view of the showerhead assembly of FIG. 8 taken along plane A-A, according to an exemplary embodiment.

FIG. 14 is another cross-section view of the showerhead assembly of FIG. 8 taken along plane A-A, according to an exemplary embodiment.

### DETAILED DESCRIPTION

Following below are more detailed descriptions of various concepts related to showerhead assemblies that allow for a person to change a configuration of the showerhead. The various concepts introduced above and discussed in greater detail below may be implemented in any of a number of ways, as the described concepts are not limited to any particular manner of implementation. Examples of specific implementation and applications are provided primarily for illustrative purposes.

### I. Overview

Showerhead assemblies (e.g., modular showerhead assemblies, showerhead kits, etc.) may be installed in bathroom configurations (e.g., bathrooms, rest rooms, etc.) to provide water (e.g., a fluid, etc.) to a user during a shower, for example while the user is showering in the bathroom configuration. In some applications, the showerhead assembly may be installed on a ceiling of the bathroom configuration (e.g., in a showering area, above a bathtub, etc.). For example, the showerhead assembly may be configured as rain showerhead assembly that is configured to be installed on the ceiling of the bathroom configuration and output water substantially straight downward onto the user. In some applications, the showerhead assembly may be installed on a wall of the bathroom configuration (e.g., in the showering area, above the bathtub, etc.). For example, the showerhead assembly may be configured as a wall mounted showerhead assembly that is configured to be installed on the wall of the bathroom configuration and output water at an angle (e.g., an angle relative to substantially straight downward, etc.) toward the user. The position of the showerhead assembly when installed in the bathroom configuration may be orientated such that water outputted by the showerhead assembly (e.g., through a nozzle of a showerhead of the showerhead assembly, etc.) is directed toward a showering area of the bathroom configuration (e.g., a showering area configured to contain the water outputted by the showerhead assembly, a showering area including a drain configured to drain the water outputted by the showerhead assembly, etc.).

When installing the showerhead assembly, particularly non-commercial configurations such as for a home, hotel, resort, or the like, the user may desire to change a configuration of the showerhead assembly. For example, the user may desire to change the configuration of the showerhead assembly to match an aesthetic of the bathroom configuration or to change a height of the showerhead assembly (e.g., to change a distance from the nozzle of the showerhead assembly to the user, etc.). In some instances, an outer ring (e.g., a first outer ring, etc.) of the showerhead assembly may be exchanged (e.g., swapped, etc.) by the user for another outer ring (e.g., a second outer ring, etc.) to change an appearance of the showerhead assembly. In some instances, multiple components of the showerhead assembly may be configured to be mounted to a surface of the bathroom configuration, such that the user may choose which of the components of the showerhead assembly the user desires to mount to the surface of the bathroom configuration. By choosing different components of the showerhead assembly to mount to the surface of the bathroom configuration, the user may change a position of a nozzle of the showerhead assembly, resulting in a modification of a location where the water is outputted by the showerhead assembly. Typical showerhead assemblies are not configured to allow for a user to change the appearance or the position of the nozzle of the showerhead assembly.

Implementations described herein are related to showerhead assemblies that are configured to be modified by a user. As a result, the user may easily modify the configuration of the showerhead assembly to achieve the configuration of the showerhead assembly that is desired by the user.

### II. Example Showerhead Assembly

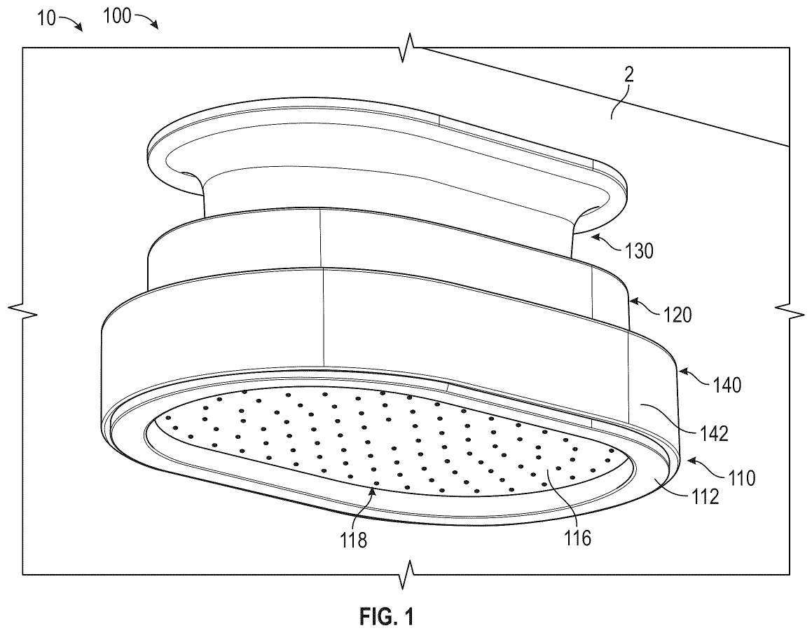

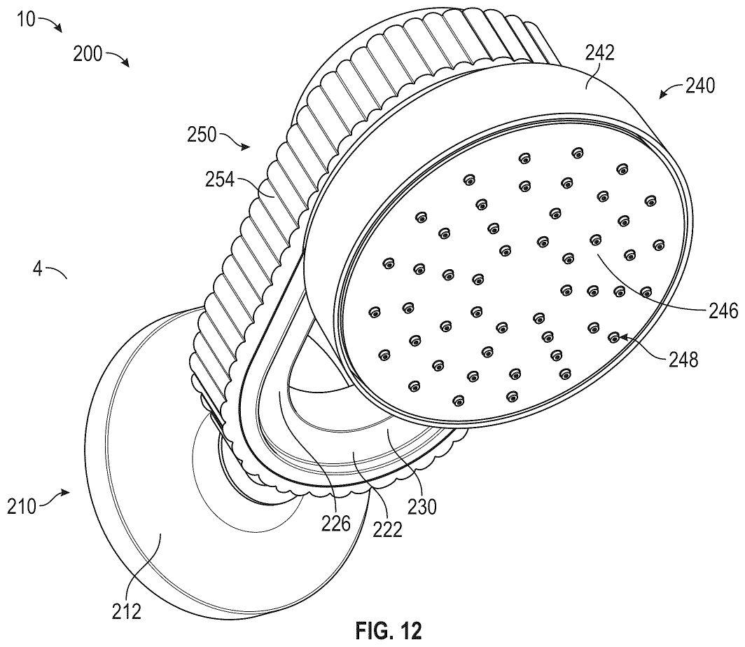

Referring to FIGS. 1-5, 8-10, and 12, a showerhead assembly 10 (e.g., a showerhead kit, a modular showerhead assembly, etc.) is shown, according to some embodiments. The showerhead assembly 10 is configured to be installed on a surface of a bathroom configuration within a showering environment (e.g., a showering area, etc.). According to various embodiments, the showerhead assembly 10 may be configured to be installed (e.g., mounted, etc.) on a ceiling of the bathroom configuration within the showering environment or a wall (e.g., a vertical wall, etc.) of the bathroom configuration within the showering embodiment. The showerhead assembly 10 is configured to receive a flow of a fluid (e.g., water, etc.) from a water supply and provide the water to a user of the showerhead assembly 10. For example, the showerhead assembly 10 may be configured to fluidly couple to a water supply pipe extending through the surface of the bathroom configuration such that showerhead assembly 10 may receive a flow of water from the water supply pipe. The water supply pipe may be connected to a water source such as a residential water supply or a hot water head. In some instances, the water supply pipe may be connected to a shower valve system configured to control the flow of water supplied to the showerhead assembly 10. For example, the shower valve system may control a temperature of the water supplied to the showerhead assembly 10, a flow rate of the water supplied to the showerhead assembly 10, etc.

Referring to FIGS. 1-5, the showerhead assembly 10 is configured as a rain showerhead assembly 100 (e.g., a ceiling-mounted showerhead assembly, a rain racetrack showerhead assembly etc.), according to some embodiments. The rain showerhead assembly 100 is configured to be installed on a ceiling surface 2 (e.g., a substantially horizontal surface, a horizontal surface, a ceiling, etc.) of the bathroom configuration within the showering environment and is configured to output water substantially downward (e.g., vertically downward, etc.). For example, the rain showerhead assembly 100 may be configured to output water downward to emulate rain falling from the sky. In some embodiments, the rain showerhead assembly 100 is configured to receive the flow of water from a water supply pipe extending through the ceiling surface 2. In other embodiments, the rain showerhead assembly 100 is configured to receive the flow of water from a water supply pipe positioned above the ceiling surface 2.

In some embodiments, the rain showerhead assembly 100 is configured to be coupled to the water supply pipe extending through the ceiling surface 2 to couple the rain showerhead assembly 100 to the ceiling surface 2. For example, the rain showerhead assembly 100 may include threads configured to engage threads of the water supply pipe and the rain showerhead assembly 100 may be configured to be coupled to the bathroom configuration when the threads of the rain showerhead assembly 100 are engaged with the threads of the water supply pipe. In other embodiments, the rain showerhead assembly 100 may be configured to couple to the ceiling surface 2. For example, the rain showerhead assembly 100 may be configured to be coupled to the ceiling surface 2 using adhesive, fasteners, mounting brackets, or any other mounting method. In some embodiments, the rain showerhead assembly 100 is configured to couple to a bracket coupled to the ceiling surface 2 to couple the rain showerhead assembly 100 to the ceiling surface 2.

As shown in FIGS. 1-5, the rain showerhead assembly 100 includes a showerhead 110 (e.g., a nozzle component, a spray head, etc.) configured to supply a flow of water to a user of the rain showerhead assembly 100, according to some embodiments. The showerhead 110 is configured to be installed on the ceiling surface 2. In some embodiments, the showerhead 110 is configured to couple to the water supply pipe of the bathroom configuration to couple the rain showerhead assembly 100 to the bathroom configuration. For example, the showerhead 110 may include a flange configured to couple to a flange of the water supply pipe to couple the rain showerhead assembly 100 to the bathroom configuration. In other embodiments, the showerhead 110 is configured to be coupled to the ceiling surface 2 to couple the rain showerhead assembly 100 to the ceiling surface 2. For example, the showerhead 110 may be coupled to the ceiling surface 2 using adhesive, fasteners, mounting brackets, or any other mounting method.

The showerhead 110 includes a showerhead body 112 configured to be installed on the ceiling surface 2. In some embodiments, the showerhead body 112 is configured to couple to the water supply pipe to couple the rain showerhead assembly 100 to the bathroom configuration. For example, the showerhead body 112 may define a portion configured to receive the water supply pipe to couple the showerhead body 112 to the water supply pipe. In other embodiments, the showerhead body 112 is configured to be coupled to the ceiling surface 2 to couple the rain showerhead assembly 100 to the bathroom configuration.

The showerhead body 112 defines a first contact surface 114 configured to be positioned proximate (e.g., contact, abut against, etc.) the ceiling surface 2 when the showerhead 110 is installed on the ceiling surface 2. The first contact surface 114 may be positioned at a first distance from the ceiling surface 2 when the showerhead 110 is installed on the ceiling surface 2. For example, when the rain showerhead assembly 100 is in a first configuration, the showerhead 110 may be positioned proximate the ceiling surface 2. The first distance may be substantially equal to zero. In some embodiments, the first contact surface 114 is configured to be coupled to the ceiling surface 2. For example, when the showerhead 110 is configured to be coupled to the ceiling surface 2, the first contact surface 114 may be configured to be coupled to the ceiling surface 2. In other embodiments, the first contact surface 114 is configured to contact or be spaced off from the ceiling surface 2. For example, when the showerhead 110 is configured to couple to the water supply pipe to couple the rain showerhead assembly 100 to the bathroom configuration, the first contact surface may contact or be spaced off from the ceiling surface 2 when the showerhead 110 is coupled to the water supply pipe.

The showerhead 110 also includes a spray plate 116 (e.g., a nozzle, a spray face, etc.) coupled to the showerhead body 112 and configured to receive the flow of water from the showerhead body 112 and to supply the flow of water to the user of the rain showerhead assembly 100. The spray plate 116 may define a plurality of spray apertures 118 (e.g., nozzle apertures, spray holes, etc.) configured to receive the flow of water from the showerhead body 112 and/or the water supply pipe and provide the flow of water to the user of the rain showerhead assembly 100. In some embodiments, the spray apertures 118 may be oriented substantially downward such that the flow of water outputted through the spray aperture 118 is substantially downward. In other embodiments, the spray apertures 118 may be oriented at angles other than substantially downward such that the flow of water outputted through the spray apertures is at angles other than substantially downward. In other embodiments, the spray apertures 118 may have two or more orientations, such as a first plurality of spray apertures angled and a second plurality of spray apertures straight down. In various embodiments, the spray plate 116 defines additional pluralities of spray apertures (e.g., a first plurality of spray apertures, a second plurality of spray apertures, etc.) that are configured as different outlets of the rain showerhead assembly 100. For example, the rain showerhead assembly 100 may include a valve that may be operated to direct the flow of water through the first plurality of spray apertures and/or the second plurality of spray apertures based on a user input from the user of the rain showerhead assembly 100.

In some embodiments, the spray plate 116 may be recessed into the showerhead body 112 such that a lower surface of the spray plate 116 is positioned above a lower surface of the showerhead body 112. By recessing the spray plate 116 into the showerhead body 112, the showerhead 110 may limit an amount of the flow of water directed in directions other than substantially downward. For example, when the spray plate 116 is recessed into the showerhead body 112, a portion of the flow of water provided by the spray apertures 118 that is not directed substantially downward may contact an inner surface of the showerhead body 112 after being provided by the spray aperture 118, preventing the flow of water from spraying in a direction other than substantially downward. In other embodiments, the spray plate 116 is not recessed into the showerhead body 112 (e.g., the lower surface of the spray plate 116 is positioned below the lower surface of the showerhead body 112, the lower surface of the spray plate 116 is positioned even with lower surface of the showerhead body 112, etc.).

As shown in FIGS. 1, 2, 4, and 5 the rain showerhead assembly 100 includes an intermediate component 120 (e.g., an intermediate plate, a top hat, etc.) also configured to be installed on the ceiling surface 2. When the intermediate component 120 is installed on the ceiling surface 2 as part of the rain showerhead assembly 100, the intermediate component 120 is positioned between the showerhead 110 and the ceiling surface 2 such that the showerhead 110 is positioned a second distance away from the ceiling surface 2. For example, when the rain showerhead assembly 100 is in a second configuration, the intermediate component 120 may be positioned proximate the ceiling surface 2 and the intermediate component 120 may be positioned between the showerhead 110 and the ceiling surface. The second distance may be greater than the first distance. In some embodiments, when the intermediate component 120 is installed on the ceiling surface 2 as part of the rain showerhead assembly 100, the intermediate component 120 is positioned on (e.g., rests on, is supported by, etc.) the first contact surface 114 of the showerhead 110. For example, when the showerhead 110 is coupled to the water supply pipe to couple the rain showerhead assembly 100 to the bathroom configuration, the intermediate component 120 may be positioned on the first contact surface 114 of the showerhead 110 such that the intermediate component 120 is positioned between the showerhead 110 and the ceiling surface 2. In other embodiments, when the intermediate component 120 is installed in the ceiling surface 2 as part of the rain showerhead assembly 100, the intermediate component 120 is coupled to the showerhead 110 and the intermediate component 120 is coupled to the ceiling surface 2 to couple the rain showerhead assembly 100 to the ceiling surface 2. For example, the intermediate component 120 may be coupled to the ceiling surface 2 using adhesive, fasteners, mounting brackets, or any other mounting method.

The intermediate component 120 defines a second contact surface 122 configured to be positioned proximate (e.g., contact, abut against, etc.) the ceiling surface 2 when the intermediate component 120 is installed on the ceiling surface 2 as part of the rain showerhead assembly 100. In some embodiments, the second contact surface 122 is configured to be coupled to the ceiling surface 2. For example, when the intermediate component 120 is installed on the ceiling surface 2 as part of the rain showerhead assembly 100 and the intermediate component 120 is coupled to the ceiling surface 2 to couple the rain showerhead assembly 100 to the ceiling surface 2, the second contact surface 122 may be coupled to the ceiling surface 2. In other embodiments, the second contact surface 122 is configured to contact or be spaced off from the ceiling surface 2 when the intermediate component 120 is installed on the ceiling surface 2 as part of the rain showerhead assembly 100. For example, when the showerhead 110 is coupled to the water supply pipe to couple the rain showerhead assembly 100 to the bathroom configuration, the intermediate component 120 may be positioned on the first contact surface 114 of the showerhead 110 and the second contact surface 122 may contact or be spaced off from the ceiling surface 2.

In some embodiments, the intermediate component 120 is configured to couple to the water supply pipe, receive the flow of water from the water supply pipe, and provide the flow of water to the showerhead 110 such that the flow of water may be outputted through the spray apertures 118. In some embodiments, the intermediate component 120 is configured to couple to the water supply pipe to couple the rain showerhead assembly 100 to the bathroom configuration when the intermediate component 120 is installed on the ceiling surface 2 as part of the rain showerhead assembly 100.

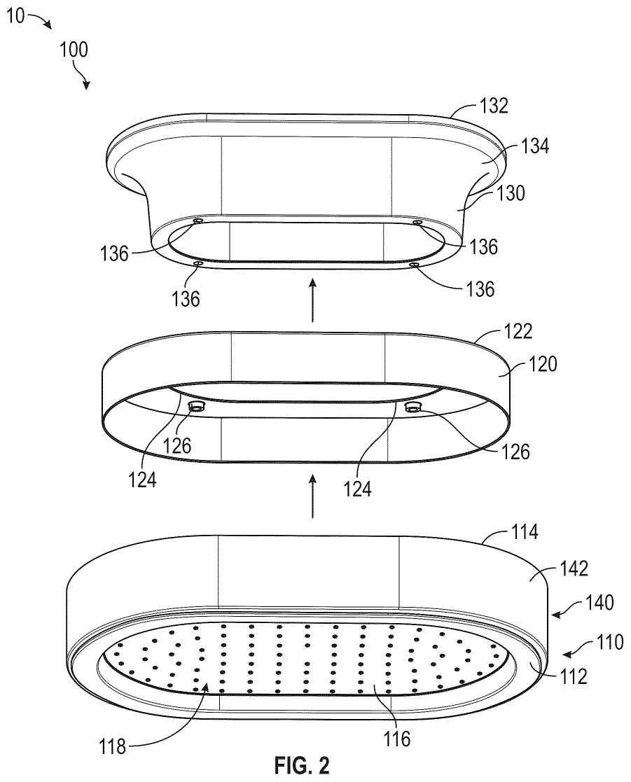

As shown in FIG. 2, the intermediate component 120 defines a plurality of intermediate apertures 124 configured to receive a plurality of fasteners 126, according to some embodiments. Each of the fasteners 126 is configured to extend through one of the intermediate apertures 124 to couple the intermediate component 120 to another component of the rain showerhead assembly 100. For example, each of the intermediate apertures 124 may align with one of a plurality of showerhead apertures defined by the showerhead 110 to selectively receive one of the fasteners 126 to couple the intermediate component 120 to the showerhead 110. The showerhead apertures defined by the showerhead 110 may extend at least partially though the showerhead 110. In some embodiments, each of the fasteners 126 is also configured to extend through one of the intermediate apertures 124 to couple the intermediate component 120 to the ceiling surface 2 (e.g., when the intermediate component 120 is configured to be installed on the ceiling surface 2, etc.).

As shown in FIGS. 1, 2, and 5, the rain showerhead assembly 100 includes a base component 130 (e.g., a base, a base plate, a chandelier, etc.) also configured to be installed on the ceiling surface 2, according to some embodiments. When the base component 130 is installed on the ceiling surface 2 as part of the rain showerhead assembly 100, the base component 130 is positioned between (i) the showerhead 110 and the intermediate component 120 and (ii) the ceiling surface 2 such that the showerhead 110 is positioned a third distance away from the ceiling surface 2. For example, when the rain showerhead assembly 100 is in a third configuration, the base component 130 may be positioned proximate the ceiling surface 2, the base component 130 may be positioned between the intermediate component 120 and the ceiling surface, and the intermediate component 120 may be positioned between the showerhead 110 and the base component 130. The third distance may be greater than the second distance. In some embodiments, when the base component 130 is installed on the ceiling surface 2 as part of the rain showerhead assembly 100, the base component 130 is positioned on (e.g., rests on, is supported by, etc.) the second contact surface 122 of the intermediate component 120. For example, when the showerhead 110 is coupled to the water supply pipe to couple the rain showerhead assembly 100 to the bathroom configuration, the intermediate component 120 may be positioned on the first contact surface 114 of the showerhead 110 and the base component 130 may be positioned on the second contact surface 122 of the intermediate component 120 such that the base component 130 is positioned between (i) the intermediate component 120 and the showerhead 110 and (ii) the ceiling surface 2. In other embodiments, when the base component 130 is installed on the ceiling surface 2 as part of the rain showerhead assembly 100, the base component 130 is coupled to the intermediate component 120, the intermediate component 120 is coupled to the showerhead 110, and the base component 130 is coupled to the ceiling surface 2 to couple the rain showerhead assembly 100 to the ceiling surface 2. For example, the base component 130 may be coupled to the ceiling surface 2 using adhesive, fasteners, mounting brackets, or any other mounting method.

The base component 130 defines a third contact surface 132 configured to be positioned proximate (e.g., contact, abut against, etc.) the ceiling surface 2 when the base component 130 is installed on the ceiling surface 2 as part of the rain showerhead assembly 100. In some embodiments, the third contact surface 132 is configured to be coupled to the ceiling surface 2. For example, when the base component 130 is installed on the ceiling surface 2 as part of the rain showerhead assembly 100 and the base component 130 is coupled to the ceiling surface 2 to couple the rain showerhead assembly 100 to the ceiling surface 2, the third contact surface 132 may be coupled to the ceiling surface 2. In other embodiments, the third contact surface 132 is configured to contact or be spaced off from the ceiling surface 2 when the base component 130 is installed on the ceiling surface 2 as part of the rain showerhead assembly 100. For example, when the showerhead 110 is coupled to the water supply pipe to couple the rain showerhead assembly 100 to the bathroom configuration, the base component 130 may be positioned on the second contact surface 122 of the intermediate component 120, the intermediate component 120 may be positioned on the first contact surface 114 of the showerhead 110, and the third contact surface 132 may contact or be spaced off from the ceiling surface 2.

In some embodiments, the base component 130 is configured to couple to the water supply pipe, receive the flow of water from the water supply pipe, and provide the flow of water to the intermediate component 120 which provides the flow of water to the showerhead 110 such that the flow of water may be outputted through the spray apertures 118. In some embodiments, the intermediate component 120 is configured to couple to the water supply pipe to couple the rain showerhead assembly 100 to the bathroom configuration when the base component 130 is installed on the ceiling surface 2 as part of the rain showerhead assembly 100.

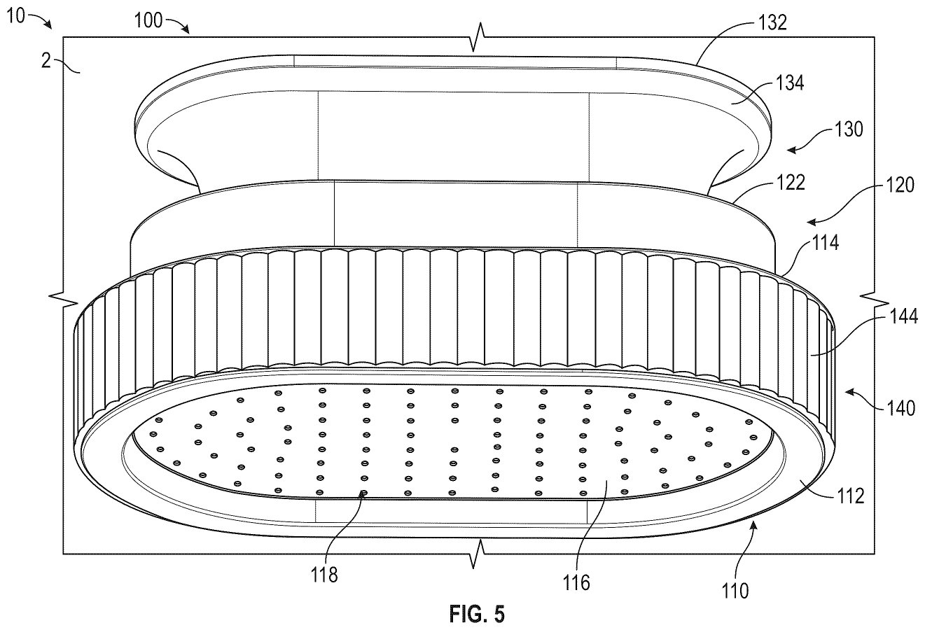

As shown in FIGS. 2 and 5, the base component 130 includes a flared base 134 configured to be installed on the ceiling surface 2. The flared base 134 may have a footprint (e.g., a cross sectional area, etc.) that is larger than a base footprint of a remainder of the base component 130 along a height of the base component 130. The flared base 134 may increase a contact surface area of the third contact surface 132 configured to be positioned proximate the ceiling surface 2 which may increase a stability of the rain showerhead assembly 100 when the base component 130 is installed on the ceiling surface 2 as part of the rain showerhead assembly 100. In other embodiments, the base component 130 does not include the flared base 134 and the base component 130 has a footprint that is substantially equal along the height of the base component 130.

As shown in FIG. 2, the base component 130 defines a plurality of base apertures 136, each configured to receive one of the fasteners 126, according to some embodiments. Each of the fasteners 126 may extend through one of the intermediate apertures 124 of the intermediate component 120 and one of the base apertures 136 of the base component 130 to couple the intermediate component 120 to the base component 130. For example, each of the base apertures 136 may define threads configured to engage threads defined each of the fasteners 126 and when one of the fasteners 126 extends through one of the intermediate apertures 124 and engages the threads of one of the base apertures 136, the fasteners 126 may couple the intermediate component 120 and the base component 130. As another example, each of the base apertures 136 may align with one of the showerhead apertures defined by the showerhead 110 and one of the intermediate apertures 124 to selectively receive one of the fasteners 126 to couple the intermediate component 120 and the showerhead 110 to the base component 130.

In various embodiments, the rain showerhead assembly 100 includes additional components (e.g., a fourth component, a fifth component, etc.) that may be selectively included in the rain showerhead assembly 100 when the rain showerhead assembly 100 is installed on the ceiling surface 2 that space the showerhead 110 further away from the ceiling surface 2. For example, when the fourth component is selectively included in the rain showerhead assembly 100, the showerhead 110 may be a fourth distance away from the ceiling surface 2 when the rain showerhead assembly 100 is installed on the ceiling surface 2. As another example, when the fifth component is selectively included in the rain showerhead assembly 100, the showerhead 110 may be a fifth distance away from the ceiling surface 2 when the rain showerhead assembly 100 is installed on the ceiling surface 2.

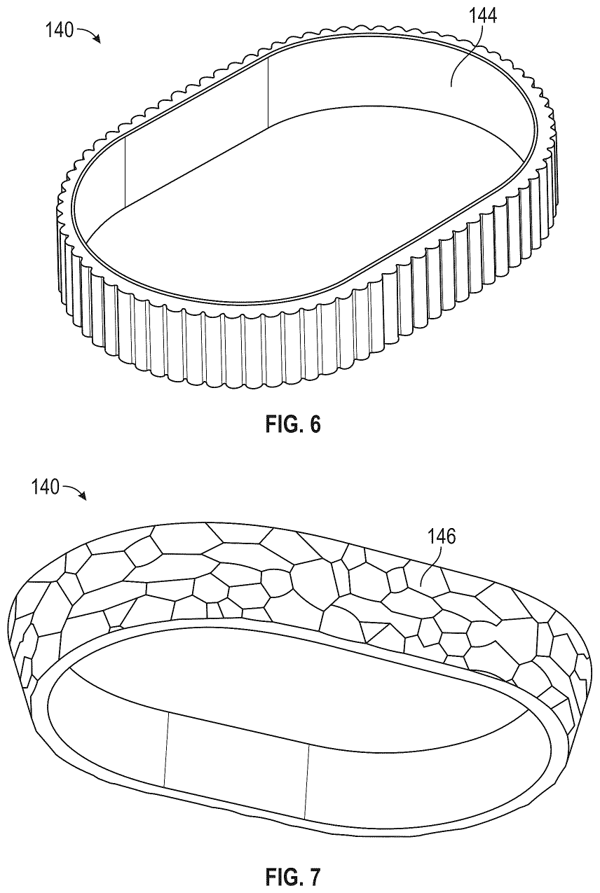

As shown in FIGS. 1-7, the rain showerhead assembly 100 also includes an outer band 140 (e.g., a decorative band, etc.) coupled to the showerhead 110, according to some embodiments. For example, the showerhead body 112 of the showerhead 110 may define an outer groove configured to receive the outer band 140 and the outer band 140 may be received by the outer groove to couple the outer band 140 to the showerhead 110. In some embodiments, when the outer band 140 is coupled to the showerhead 110 the outer band 140 may encircle the showerhead 110 (e.g., wrap fully around a cross section of the showerhead 110, etc.). In other embodiments, the outer band 140 may be coupled to the intermediate component 120 and/or the base component 130. For example, the intermediate component 120 and/or the base component 130 may define the outer groove configured to receive the outer band 140 and the outer band 140 may be received by the outer groove to couple the outer band 140 to the intermediate component 120 and/or the base component 130. In various embodiments, the rain showerhead assembly 100 may include multiple of the outer bands 140 coupled to at least two of the showerhead 110, the intermediate component 120, or the base component 130.

As shown in FIGS. 1-7, the outer band 140 may be configured to have a racetrack shape (e.g., an ovular shape, a loop shape, etc.). In other embodiments, the outer band 140 may have a different shape (e.g., a square shape, a circular shape, etc.).

As shown in FIGS. 1-7, the rain showerhead assembly 100 includes a plurality of the outer bands 140 arranged in different configuration, according to some embodiments. The rain showerhead assembly 100 may selectively couple with the outer bands 140 to facilitate selectively interchanging the outer band 140. Each of the outer bands 140 may gave a different physical characteristic such that selectively interchanging the outer bands 140 changes an appearance of the rain showerhead assembly 100. For example, the rain showerhead assembly 100 may include a first outer band 142 configured as a plain metal band, a second outer band 144 configured as a grooved band, and a third outer band 146 configured as a textured band. One of the outer bands 140 may be coupled to the showerhead 110 when the rain showerhead assembly 100 is installed on the ceiling surface 2. The outer bands 140 may be engaged with the rain showerhead assembly by friction fit, magnetic, elastic engagement, or similar structures. For example, when the rain showerhead assembly 100 is installed on the ceiling surface 2, one of the first outer band 142, the second outer band 144, or the third outer band 146 may be received by the outer groove of the showerhead body 112 of the showerhead 110 to couple the one of the first outer band 142, the second outer band 144, or the third outer band 146 to the showerhead 110.

The user of the rain showerhead assembly 100 may exchange (e.g., swap, etc.) the outer band 140 coupled to the showerhead 110 with another of the outer bands 140 to change a configuration of the rain showerhead assembly 100. In some embodiments, the user may exchange the outer band 140 coupled to the showerhead 110 with another of the outer bands 140 without uninstalling the rain showerhead assembly 100 from the ceiling surface 2. In other embodiments, the user must uninstall the rain showerhead assembly 100 from the ceiling surface 2 in order to exchange the outer band 140 coupled to the showerhead 110 with another of the outer bands 140. In still other embodiments, the manufacturer may install the one of the outer bands 140 while manufacturing (e.g., assembling, etc.) the rain showerhead assembly 100.

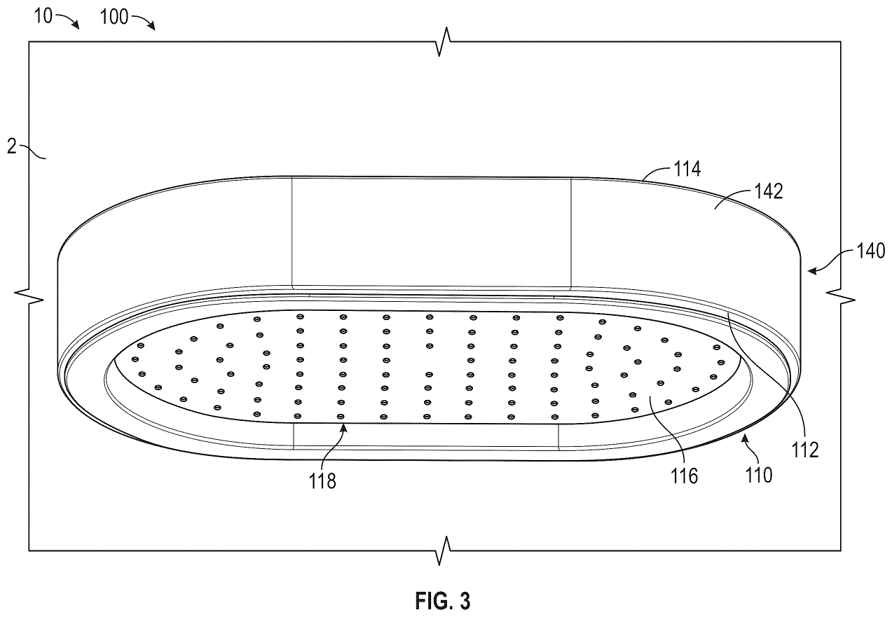

As shown in FIG. 3, the rain showerhead assembly 100 may be installed on the ceiling surface 2 in a first configuration, according to some embodiments. In the first configuration, the rain showerhead assembly 100 may be configured to selectively include the showerhead 110 and the showerhead 110 may be installed on the ceiling surface 2. In the first configuration, the first contact surface 114 may be positioned proximate the ceiling surface 2 when the rain showerhead assembly 100 is installed on the ceiling surface 2. In some embodiments, when the rain showerhead assembly 100 is installed on the ceiling surface 2 in the first configuration, the first contact surface 114 of the showerhead 110 is coupled to the ceiling surface 2 to couple the rain showerhead assembly 100 to the ceiling surface 2. In other embodiments, the first contact surface 114 contacts or is spaced off from the ceiling surface 2 when the rain showerhead assembly 100 is installed on the ceiling surface 2 in the first configuration (e.g., when the showerhead 110 is coupled to the water supply pipe to couple the rain showerhead assembly 100 to the bathroom configuration, etc.). When the rain showerhead assembly 100 is installed on the ceiling surface 2 in the first configuration, a first distance between the first contact surface 114 and the ceiling surface 2 may be substantially equal to zero (e.g., such that the first contact surface 114 contacts or nearly contacts the ceiling surface 2, etc.).

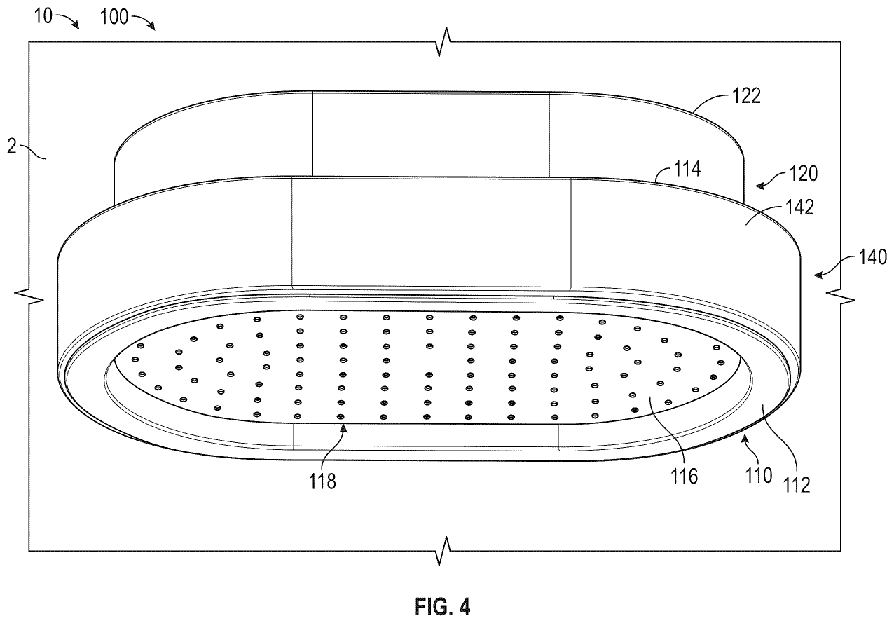

As shown in FIG. 4, the rain showerhead assembly 100 may be installed on the ceiling surface 2 in a second configuration, according to some embodiments. In the second configuration, the rain showerhead assembly 100 may be configured to selectively include the showerhead 110 and the intermediate component 120 and the intermediate component 120 may be installed on the ceiling surface 2. In the second configuration, the intermediate component 120 may be positioned between the showerhead 110 and the ceiling surface 2. In the second configuration, the second contact surface 122 of the intermediate component 120 may be positioned proximate the ceiling surface when the rain showerhead assembly 100 is installed on the ceiling surface 2. In some embodiments, when the rain showerhead assembly 100 is installed on the ceiling surface 2 in the second configuration, the second contact surface 122 of the intermediate component 120 is coupled to the ceiling surface 2 to couple the rain showerhead assembly 100 to the ceiling surface 2. In other embodiments, the second contact surface 122 contacts or is spaced off from the ceiling surface 2 when the rain showerhead assembly 100 is installed on the ceiling surface 2 in the second configuration (e.g., when the showerhead 110 is coupled to the water supply pipe to couple the rain showerhead assembly 100 to the bathroom configuration and the intermediate component 120 is positioned on the first contact surface 114 of the showerhead 110, etc.). When the rain showerhead assembly 100 is installed on the ceiling surface 2 in the second configuration, a second distance between the first contact surface 114 and the ceiling surface 2 is greater than the first distance between the first contact surface 114 and the ceiling surface 2 when the rain showerhead assembly 100 is installed on the ceiling surface 2 in the first configuration such that the spray plate 116 is positioned further from the ceiling surface 2 in the second configuration than in the first configuration.

As shown in FIG. 5, the rain showerhead assembly 100 may be installed on the ceiling surface 2 in a third configuration, according to some embodiments. In the third configuration, the rain showerhead assembly 100 may be configured to selectively include the showerhead 110, the intermediate component 120, and the base component 130 and the base component 130 may be installed on the ceiling surface 2. In the third configuration, the base component 130 may be positioned between (i) the showerhead 110 and the intermediate component 120 and (ii) the ceiling surface 2. In the third configuration, the third contact surface 132 of the base component 130 may be positioned proximate the ceiling surface when the rain showerhead assembly 100 is installed on the ceiling surface 2. In some embodiments, when the rain showerhead assembly 100 is installed on the ceiling surface 2 in the third configuration, the third contact surface 132 of the base component 130 is coupled to the ceiling surface 2 to couple the rain showerhead assembly 100 to the ceiling surface 2. In other embodiments, the third contact surface 132 contacts or is spaced off from the ceiling surface 2 when the rain showerhead assembly 100 is installed on the ceiling surface 2 in the third configuration (e.g., when the showerhead 110 is coupled to the water supply pipe to couple the rain showerhead assembly 100 to the bathroom configuration, the intermediate component 120 is positioned on the first contact surface 114 of the showerhead 110, and the base component 130 is positioned on the second contact surface 122 of the intermediate component 120, etc.). When the rain showerhead assembly 100 is installed on the ceiling surface 2 in the third configuration, a third distance between the first contact surface 114 and the ceiling surface 2 is greater than (i) the first distance between the first contact surface 114 and the ceiling surface 2 when the rain showerhead assembly 100 is installed on the ceiling surface 2 in the first configuration such that the spray plate 116 is positioned further from the ceiling surface 2 in the third configuration than in the first configuration and (ii) the second distance between the first contact surface 114 and the ceiling surface 2 when the rain showerhead assembly 100 is installed on the ceiling surface 2 in the second configuration such that the spray plate 116 is positioned further from the ceiling surface 2 in the third configuration than in the second configuration.

In various embodiments, the rain showerhead assembly 100 may be installed on the ceiling surface 2 in additional configurations (e.g., a fourth configuration, a fifth configuration, etc.). For example, in the fourth configuration the rain showerhead assembly 100 may be configured to selectively include the showerhead 110, the intermediate component 120, the base component 130, and a fourth component and a fourth distance between the first contact surface 114 and the ceiling surface 2 may be greater than the first distance between the first contact surface 114 and the ceiling surface 2, the second distance between the first contact surface 114 and the ceiling surface 2, and the third distance between the first contact surface 114 and the ceiling surface 2. As another example, in the fifth configuration the rain showerhead assembly 100 may be configured to selectively include the showerhead 110, the intermediate component 120, the base component 130, the fourth component, and a fifth component and a fifth distance between the first contact surface 114 and the ceiling surface 2 may be greater than the first distance between the first contact surface 114 and the ceiling surface 2, the second distance between the first contact surface 114 and the ceiling surface 2, the third distance between the first contact surface 114 and the ceiling surface 2, and the fourth distance between the first contact surface 114 and the ceiling surface 2.

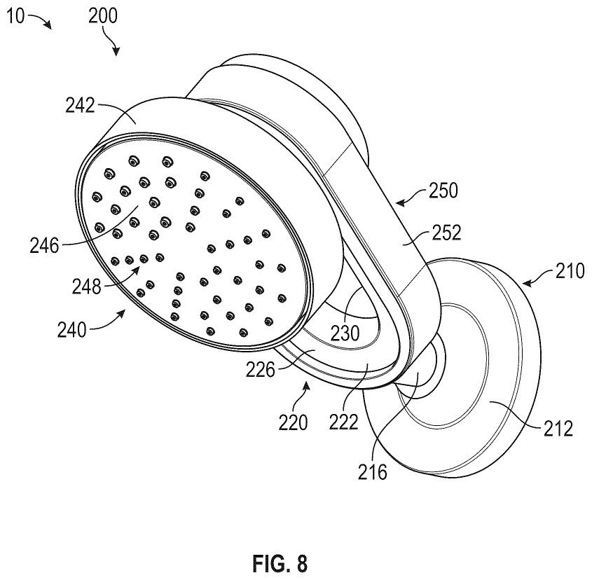

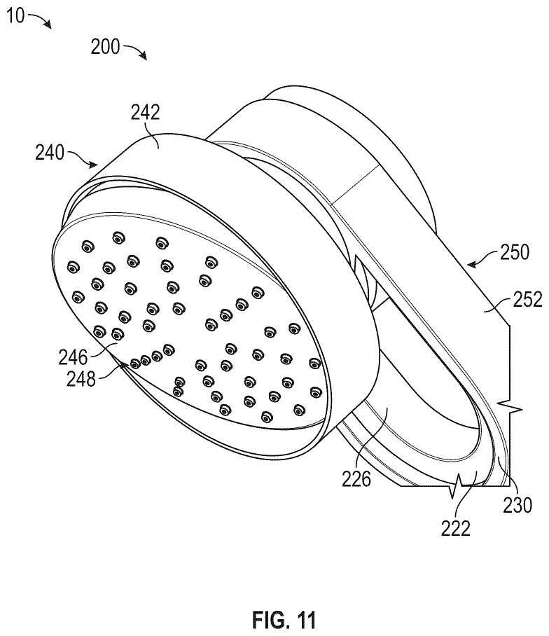

Referring to FIGS. 8-14, the showerhead assembly 10 is configured as a wall showerhead assembly 200 (e.g., a wall-mounted showerhead assembly, a racetrack wall mount showerhead assembly, etc.), according to some embodiments. The wall showerhead assembly 200 is configured to be installed on a wall surface 4 (e.g., a substantially vertical surface, a wall, etc.) of the bathroom configuration within the showering environment and is configured to provide a flow of water to a user. For example, the wall showerhead assembly 200 may be configured to output the flow of water at an angle away from the wall surface. In some embodiments, the wall showerhead assembly 200 is configured to receive the flow of water from a water supply pipe positioned behind the wall surface 4. In other embodiments, the wall showerhead assembly 200 is configured to receive the flow of water from a water supply pipe extending through the wall surface 4.

As shown in FIGS. 8-10 and 12, the wall showerhead assembly 200 includes a wall mount 210 (e.g., a wall mount component, a wall mount portion, etc.) configured to couple to the wall surface 4 and receive the flow of water from the water supply pipe, according to some embodiments. The wall mount 210 may be installed on the wall surface 4 when the wall showerhead assembly 200 is installed on the wall surface 4. The wall mount 210 includes a base portion 212 that defines a contact surface 214 configured to be positioned proximate (e.g., contact, abut against, etc.) the wall surface 4 when the wall showerhead assembly 200 is installed on the wall surface 4. In some embodiments, the contact surface 214 is configured to be coupled to the wall surface 4. For example, when the wall showerhead assembly 200 is installed on the wall surface 4, the contact surface 214 may be coupled to the wall surface 4 to couple the wall showerhead assembly 200 to the wall surface 4. For example, the contact surface 214 of the base portion 212 may be coupled to the wall surface 4 using adhesive, fasteners, mounting brackets, or any other mounting method. In other embodiments, the contact surface 214 is configured to contact or be spaced off from the wall surface 4 when the wall showerhead assembly 200 is installed on the wall surface 4. For example, when the wall showerhead assembly 200 is coupled to the water supply pipe to couple the wall showerhead assembly 200 to the wall surface 4, the contact surface 214 may contact or be spaced off from the wall surface 4.

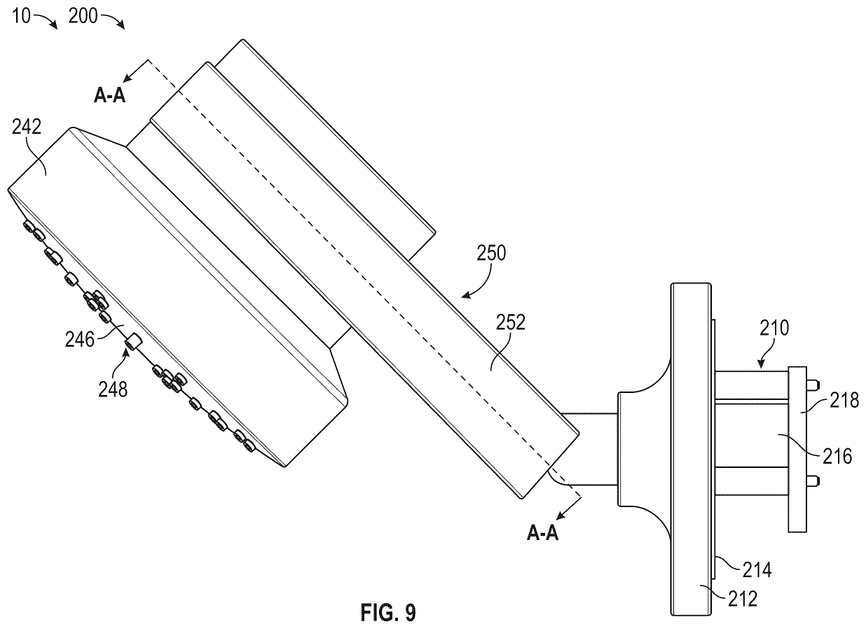

As shown in FIGS. 9, 10, 13, and 14, the wall mount 210 also includes a water supply inlet 216 (e.g., a water supply conduit, a water pipe, etc.) configured to fluidly couple to the water supply pipe and receive the flow of water from the water supply pipe. For example, the water supply inlet 216 may define threads configured to engage threads defined by the water supply pipe and the water supply inlet 216 may be fluidly coupled to the water supply pipe when the threads of the water supply inlet 216 engage the threads of the water supply pipe. In some embodiments, the water supply inlet extends through the base portion 212. In some embodiments, the water supply inlet 216 extends through the wall surface 4 when the wall showerhead assembly 200 is coupled to the wall surface 4 (e.g., when the water supply pipe is positioned behind the wall surface 4.). In other embodiments, the water supply inlet 216 does not extend through the wall surface 4 when the wall showerhead assembly 200 is coupled to the wall surface 4 (e.g., when the water supply pipe extends through the wall surface 4.

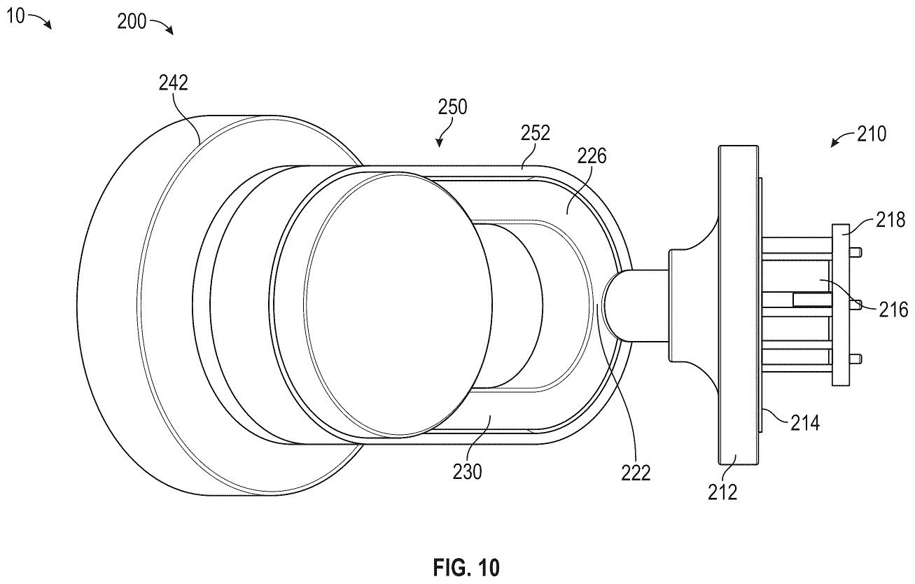

As shown in FIGS. 9 and 10, the wall mount 210 also includes a flange 218 (e.g., a flanged fitting, a flange connection, a flange joint, etc.) configured to couple to a flange of the water supply pipe to couple the water supply inlet 216 to the water supply pipe, according to some embodiments. In some embodiments, the flange 218 may couple the wall showerhead assembly 200 to the wall surface 4 when the flange 218 is coupled to the flange of the water supply pipe. In other embodiments, the flange 218 may couple the water supply inlet 216 to the water supply pipe when the flange 218 is coupled to the flange of the water supply pipe, by the wall showerhead assembly 200 may be coupled to the wall surface 4 through other means (e.g., coupled by the contact surface 214 of the base portion 212, etc.).

As shown in FIGS. 8-14, the wall showerhead assembly 200 includes a split conduit portion 220 (e.g., a conduit portion, a split conduit component, an arm portion, etc.) coupled to the water supply inlet 216 of the wall mount 210 and configured to receive the flow of water from the water supply inlet 216. The split conduit portion 220 includes an inlet 222 coupled to the water supply inlet 216. The inlet 222 defines an inlet conduit 224 (e.g., an inlet opening, etc.) fluidly coupled to the water supply inlet 216 and configured to receive the flow of water from the water supply inlet 216.

As shown in FIGS. 8-14 split conduit portion 220 also includes a first arm 226 and a second arm 230 coupled to and extending away from the inlet 222. The second arm 230 may extend substantially parallel to the first arm 226 and may be spaced a distance away from the first arm 226. In some embodiments, the first arm 226 and the second arm 230 extend substantially perpendicular to the wall surface 4. In other embodiments, the first arm 226 and the second arm 230 extend at an angle relative to the wall surface 4 (e.g., an angle other than 90 degrees, etc.). In some embodiments, the split conduit portion 220 includes additional arms (e.g., a third arm, a fourth arm, etc.) coupled to and extending away from the inlet 222.

The first arm 226 defines a first conduit 228 (e.g., a first arm conduit, etc.) fluidly coupled to the inlet conduit 224 and configured to receive a first portion of the flow of water from the inlet conduit 224. Further, in some embodiments, the second arm 230 defines a second conduit 232 (e.g., a second arm conduit, etc.) fluidly coupled to the inlet conduit 224 and configured to receive a second portion of the flow of water from the inlet conduit 224. In some embodiments, a sum of a quantity of the first portion of the flow of water and a quantity of the second portion of the flow of water is equivalent to a quantity of the flow of water. In some embodiments, the quantity of the first portion of the flow of water is equivalent to the quantity of the second portion of the flow of water. For example, a first cross sectional area of the first conduit 228 may be equal to a second cross sectional area of the second conduit 232 resulting in the flow of water being evenly split into the first portion of the flow of water in the first conduit 228 and the second portion of the flow of water in the second conduit 232. In various embodiments, the additional arms of the split conduit portion 220 define additional conduits (e.g., a third conduit, a fourth conduit, etc.) fluidly coupled to the inlet conduit 224 and configured to receive additional portions of the flow of water from the inlet conduit 224 (e.g., a third portion of the flow of water, a fourth portion of the flow of water, etc.). By having multiple conduits (e.g., the first conduit 228 and the second conduit 232, etc.) defined in multiple arms (e.g., the first arm 226 and the second arm 230, etc.), each of the first arm 226 and the second arm 230 may be thinner than a showerhead that only includes a single arm defining a single conduit. Additionally, in a situation where one of the first conduit 228 or the second conduit 232 becomes clogged (e.g., water cannot flow through the first conduit 228 or the second conduit 232, etc.), water may continue to flow through the unclogged of conduits which is not an option for the showerhead that only includes the single arm defining the single conduit.

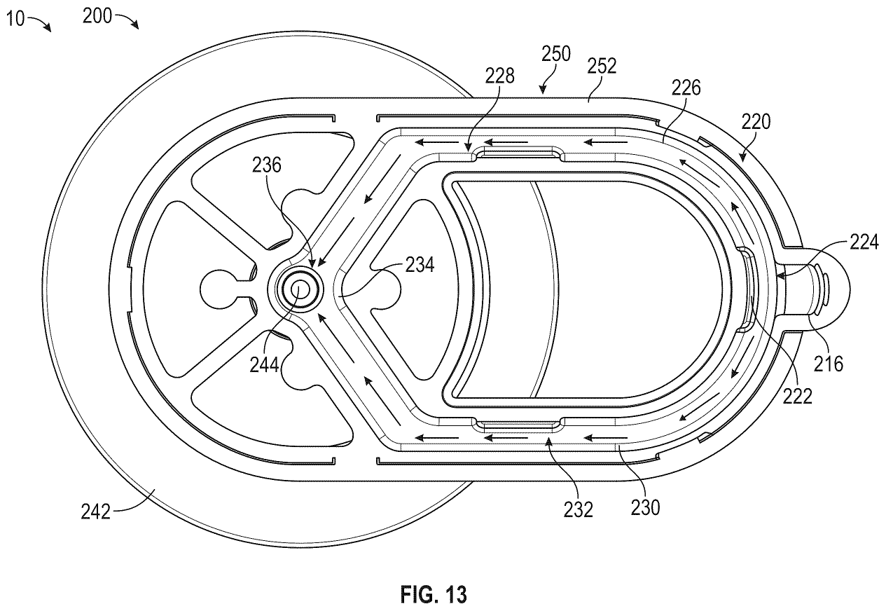

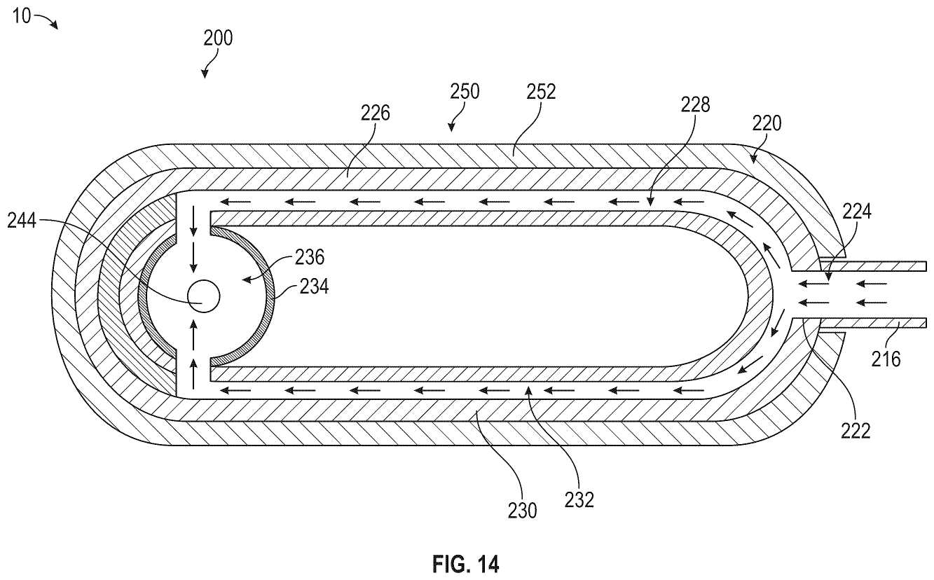

As shown in FIGS. 13 and 14, the split conduit portion 220 also includes an outlet 234 coupled to the first arm 226 and the second arm 230. In various embodiments, the outlet 234 is also coupled to the additional arms of the split conduit portion 220. The outlet 234 defines an outlet conduit 236 fluidly coupled to the first conduit 228 and the second conduit 232. The outlet conduit 236 is configured to receive the first portion of the flow of water from the first conduit 228 and the second portion of the flow of water from the second conduit 232 such that the outlet conduit 236 receives the flow of water originally provided by the water supply inlet 216 (e.g., and the water supply pipe, etc.). In various embodiments, the outlet conduit 236 is also fluidly coupled to the additional conduits defined by the additional arms and is configured to receive the additional portions of the flow of water from the additional conduits.

As shown in FIGS. 8-13, the wall showerhead assembly 200 includes a showerhead 240 (e.g., a nozzle component, a spray head, etc.) configured to supply a flow of water to a user of the wall showerhead assembly 200, according to some embodiments. The showerhead 240 is coupled to the split conduit portion 220 and is configured to receive the flow of water from the split conduit portion 220 and provide the flow of water to the user of the wall showerhead assembly 200.

The showerhead 240 includes a showerhead body 242 coupled to at least one of the outlet 234 of the split conduit portion 220, the first arm 226 of the split conduit portion 220, or the second arm of the split conduit portion 220. In some embodiments, the showerhead body is coupled to each of the outlet 234 of the split conduit portion 220, the first arm 226 of the split conduit portion 220, and the second arm of the split conduit portion 220. The showerhead body 242 defines a showerhead conduit 244 fluidly coupled to the outlet conduit 236 and configured to receive the flow of water from the outlet conduit 236. In some embodiments, the showerhead conduit 244 is oriented substantially perpendicular to the first arm 226, the first conduit 228, the second arm 230, and/or the second conduit 232.

The showerhead 240 also includes a spray plate 246 (e.g., a nozzle, a spray face, etc.) coupled to the showerhead body 242 and configured to receive the flow of water from the showerhead conduit 244 and to supply the flow of water to the user of the wall showerhead assembly 200. In some embodiments, the spray plate 246 is pivotally coupled to the showerhead body 242 to allow for the user of the wall showerhead assembly 200 to change an angle of the spray plate 246 relative to the showerhead body 242. For example, when the spray plate 246 is pivotably coupled to the showerhead body 242, a user may pivot the spray plate 246 relative to the showerhead body 242 to adjust a spray angle of the flow of water outputted by the wall showerhead assembly 200 through the spray plate 246. The spray plate 246 may define a plurality of spray apertures 248 (e.g., nozzle apertures, spray holes, etc.) configured to receive the flow of water from the showerhead conduit 244 and provide the flow of water to the user of the wall showerhead assembly 200. When the spray plate 246 is pivotally coupled to the showerhead body 242, an outlet direction of each of the spray apertures 248 may be changed when the angle of the spray plate 246 relative to the showerhead body 242 is changed. In various embodiments, the spray plate 246 defines additional pluralities of spray apertures (e.g., a first plurality of spray apertures, a second plurality of spray apertures, etc.) that are configured as different outlets of the wall showerhead assembly 200. For example, the wall showerhead assembly 200 may include a valve that may be operated to direct the flow of water through the first plurality of spray apertures and/or the second plurality of spray apertures based on a user input from the user of the wall showerhead assembly 200.

As shown in FIGS. 8-14, the wall showerhead assembly 200 also includes an outer band 250 (e.g., a decorative band, etc.) coupled to the split conduit portion 220, according to some embodiments. For example, the first arm 226, the second arm 230, and the showerhead 240 may collectively define an outer groove configured to receive the outer band 250 and the outer band 250 may be received by the outer groove to couple the outer band 250 to the split conduit portion 220. In some embodiments, when the outer band 250 is coupled to the split conduit portion 220, the outer band 250 may encircle the split conduit portion 220. In other embodiments, when the outer band 250 is coupled to the split conduit portion 220, the outer band 250 may encircle a majority (e.g., more than half, more than three quarters, etc.) of the split conduit portion 220. For example, the outer band 250 may encircle the split conduit portion 220 around a majority of the split conduit portion 220 except where the water supply inlet 216 couples to the split conduit portion 220. In still other embodiments, the outer band 250 may be coupled to the showerhead 240 and/or the wall mount 210. For example, the showerhead 240 and/or the wall mount 210 may define the outer groove configured to receive the outer band 250 and the outer band 250 may be received by the outer groove to couple the outer band 250 to the showerhead 240 and/or the wall mount 210. In various embodiments, the wall showerhead assembly 200 may include multiple of the outer bands 250 coupled to at least one of the split conduit portion 220, the showerhead 240, or the wall mount 210.

In some embodiments, the outer band 250 is coupled to the split conduit portion 220 and the showerhead 240. For example, the split conduit portion 220 and the showerhead 240 may cooperatively define the outer groove configured to receive the outer band 250 and the outer band 250 may be received by the outer groove to couple the outer band 250 to the split conduit portion 220 and the showerhead 240.

As shown in FIGS. 8-14, the outer band 250 may be configured to have a racetrack shape (e.g., an ovular shape, a loop shape, etc.). In other embodiments, the outer band 250 may have a different shape (e.g., a square shape, a circular shape, etc.).

As shown in FIGS. 8-14, the wall showerhead assembly 200 includes a plurality of the outer bands 250 arranged in different configurations, according to some embodiments. For example, the wall showerhead assembly 200 may include a first outer band 252 configured as a plain metal band and a second outer band 254 configured as a grooved band. One of the outer bands 250 may be coupled to the split conduit portion 220 when the wall showerhead assembly 200 is installed on the wall surface 4. For example, when the wall showerhead assembly 200 is installed on the wall surface 4, one of the first outer band 252 or the second outer band 254 may be received by the outer groove of the split conduit portion 220 to couple the one of the first outer band 252 or the second outer band 254 to the split conduit portion 220.

The user of the wall showerhead assembly 200 may exchange (e.g., swap, etc.) the outer band 250 coupled to the split conduit portion 220 with another of the outer bands 250 to change a configuration of the wall showerhead assembly 200. In some embodiments, the user may exchange the outer band 250 coupled to the split conduit portion 220 with another of the outer bands 250 without uninstalling the wall showerhead assembly 200 from the wall surface 4. In other embodiments, the user must uninstall the wall showerhead assembly 200 from the wall surface 4 in order to exchange the outer band 250 coupled to the split conduit portion 220 with another of the outer bands 250. In still other embodiments, the manufacturer may install the one of the outer bands 250 while manufacturing (e.g., assembling, etc.) the wall showerhead assembly 200.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components (such as the light driver) used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the cord management system as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A showerhead assembly configured to couple to a supply conduit extending through a surface, the showerhead assembly comprising:
a showerhead configured to couple to the supply conduit, the showerhead defining a plurality of nozzles;
an intermediate component configured to couple to the showerhead; and
a base component configured to couple to the intermediate component;
wherein when the showerhead assembly is in a first configuration, the showerhead is positioned proximate the surface;
wherein when the showerhead assembly is in a second configuration, the intermediate component is coupled to the showerhead and the intermediate component is positioned proximate the surface; and
wherein when the showerhead assembly is in a third configuration, the intermediate component is coupled to the showerhead, the base component is coupled to the intermediate component, and the base component is positioned proximate the surface.

2. The showerhead assembly of claim 1, wherein:
when the showerhead is in the first configuration, the showerhead is spaced a first distance from the surface; and
when the showerhead is in the second configuration, the showerhead is spaced a second distance from the surface, the second distance greater than the first distance.

3. The showerhead assembly of claim 2, wherein when the showerhead is in the third configuration, the showerhead is spaced a third distance from the surface, the third distance greater than the second distance.

4. The showerhead assembly of claim 1, wherein when the showerhead assembly is in the second configuration, the intermediate component is positioned between the showerhead and the surface.

5. The showerhead assembly of claim 1, wherein when the showerhead assembly is in the third configuration, the intermediate component is positioned between the showerhead and the base component and the base component is positioned between the intermediate component and the surface.

6. The showerhead assembly of claim 1, wherein the showerhead defines an outer groove configured to selectively receive a plurality of outer bands to facilitate selectively interchanging the plurality of outer bands.

7. The showerhead assembly of claim 6, wherein each of the plurality of outer bands has a different physical characteristic such that selectively interchanging the plurality of outer bands changes an appearance of the showerhead assembly.

8. The showerhead assembly of claim 1, wherein:
the showerhead defines a plurality of first apertures extending at least partially through the showerhead;
the intermediate component defines a plurality of second apertures extending through the intermediate component; and
when the showerhead assembly is in the second configuration, each of the plurality of second apertures is configured to align with one of the plurality of first apertures to selectively receive one of a plurality of fasteners to couple the intermediate component to the showerhead.

9. The showerhead assembly of claim 8, wherein:
the base component defines a plurality of third apertures extending through the base component; and
when the showerhead assembly is in the third configuration, each of the plurality of third apertures is configured to align with one of the plurality of first apertures and one of the plurality of second apertures to selectively receive one of a plurality of fasteners to couple the base component to the intermediate component and the showerhead.

10. The showerhead assembly of claim 8, wherein when the showerhead assembly is in the second configuration, each of the plurality of second apertures is configured to align with the one of the plurality of first apertures to selectively receive the one of a plurality of fasteners to couple the intermediate component and the showerhead to the surface.

11. The showerhead assembly of claim 1, wherein:
the base component includes a flared base, the flared base having a footprint that is larger than a base footprint of a remainder of the base component; and
the flared base abuts the surface when the showerhead assembly is in the third configuration.

12. A showerhead assembly configured to couple to a surface, the showerhead assembly comprising:
a base portion configured to couple to the surface, the base portion defining a water supply inlet configured to receive a flow of water;
an arm portion coupled to the base portion, the arm portion comprising:
a first arm defining a first conduit fluidly coupled to the water supply inlet, the first conduit configured to receive a first portion of the flow of water from the water supply inlet, and
a second arm defining a second conduit fluidly coupled to the water supply inlet, the second conduit configured to receive a second portion of the flow of water from the water supply inlet; and
a showerhead coupled to the arm portion, the showerhead defining a showerhead conduit fluidly coupled to the first conduit and the second conduit, the showerhead conduit configured to receive the first portion of the flow of water from the first conduit and the second portion of the flow of water from the second conduit.

13. The showerhead assembly of claim 12, wherein the arm portion and the showerhead collectively define an outer groove configured to selectively receive a plurality of outer bands to facilitate selectively interchanging the plurality of outer bands.

14. The showerhead assembly of claim 13, wherein each of the plurality of outer bands has a different physical characteristic such that selectively interchanging the plurality of outer bands changes an appearance of the showerhead assembly.

15. The showerhead assembly of claim 13, wherein each of the plurality of outer bands has a racetrack shape.

16. The showerhead assembly of claim 12, wherein the showerhead defines a plurality of nozzles fluidly coupled to the showerhead conduit configured to output the flow of water from the showerhead assembly.

17. The showerhead assembly of claim 16, wherein the showerhead comprises:
a showerhead body defining the showerhead conduit; and
a spray plate pivotably coupled to the showerhead body, the spray plate defining the plurality of nozzles such that a user of the showerhead assembly may pivot the spray plate relative to the showerhead body to adjust a spray angle of the flow of water outputted by the showerhead assembly.

18. A showerhead assembly configured to couple to a supply conduit extending through a surface, the showerhead assembly comprising:
a showerhead configured to couple to the supply conduit, the showerhead defining:
a showerhead conduit fluidly coupled to the supply conduit and configured to receive a flow of water from the supply conduit,
a plurality of nozzles fluidly coupled to the showerhead conduit configured to output the flow of water from the showerhead assembly, and
an outer groove configured to selectively receive a plurality of outer bands to facilitate selectively interchanging the plurality of outer bands.

19. The showerhead assembly of claim 18, wherein each of the plurality of outer bands has a different physical characteristic such that selectively interchanging the plurality of outer bands changes an appearance of the showerhead assembly.

20. The showerhead assembly of claim 18, wherein each of the plurality of outer bands has a racetrack shape.
